(19) United States
(12) Patent Application Publication
(10) Pub. No.: US 2012/0264497 A1
(43) Pub. Date: Oct. 18, 2012

(54) POKER TETRO COMPUTER GAME

(76) Inventors: Alex Iosilevsky, San Francisco, CA (US); Len Mugin, San Francisco, CA (US)

(21) Appl. No.: 13/413,082

(22) Filed: Mar. 6, 2012

Related U.S. Application Data
(60) Provisional application No. 61/517,251, filed on Apr. 18, 2011.

(51) Int. Cl. A63F 13/06

(52) U.S. Cl. 463/13

(57) ABSTRACT

Proposed is a poker tetris computer game to be played on a computer, wherein a plurality of game cards of different ranks and different suits fall in an arbitrary sequence from the top to the floor of the game frame. During the fall, a formation of cards can be manipulated as cubes in a conventional falling block game and can disintegrate once it is partially blocked by the laying cards. In this case, the unblocked portion separates from the rest of the formation and resumes the fall until blocked by other formations or by the floor of the game frame. During the fall of the falling formation, the player may navigate the formation so as to form hands that correspond winning combinations for obtaining the maximum possible number of winning points.

### RELEVANT PATENT PUBLICATIONS

This patent application is based on Provisional Patent Application No. 61/517,251 filed Apr. 18, 2011 and entitled: CARD TETRO.

### FIELD OF THE INVENTION

The present invention relates to a card game and, more particularly, to a card game that incorporates card game features into a computer game known as Tetris. More specifically, several cards are combined into a card formation. The Card Tetro allows a player to move and/or turn the card formations and to stack the formations to form hands. Cards are used to make hands by stacking card formations on top of each other or next to each other.

### BACKGROUND OF THE INVENTION

Poker is a family of card games involving betting and individualistic play whereby the winner is determined by the ranks and combinations of their cards, some of which remain hidden until the end of the game. Poker games vary in the number of cards dealt, the number of shared, or “community” cards and the number of cards that remain hidden. The betting procedures vary amongst different poker games in such ways as betting limits and splitting the pot between a high hand and a low hand.

Poker has gained in popularity since the beginning of the twentieth century, and has gone from being primarily a recreational activity confined to small groups of mostly male enthusiasts, to a widely popular spectator activity with international audiences and multi-million dollar tournament prizes, with women being a constantly growing part of that audience.

Whether played in a gaming environment, or in a non-wagering environment such as a computer game, the appeal of card games and other gaming activities is unfaltering.

Known in the art is a variety of poker games that may differ from each other by specific game rules. One particular poker genre involves poker games having a “draw,” where replacement cards may be dealt or otherwise provided to the player during play of a hand. For example, in a common variation of draw poker, the player is dealt a number of cards, such as five cards. The player looks at the cards in this initial hand, and decides which cards to hold and which to discard based on the likelihood of achieving a winning hand based on a predetermined pay table. The cards that are discarded are replaced with new cards for use with the held cards to create the resulting hand.

Traditionally, these and other poker games including such a “draw” typically involve the dealer providing the player with the number of cards required to replace the player's discarded cards. In electronic embodiments, a computer-based system such as a video poker machine electronically provides the player with the replacement cards. The ability to receive dealer-furnished replacement cards allows the player to experience additional anticipation and optimism in achieving a winning hand, over non-draw poker games such as stud poker games.

However, such conventional draw poker games are limited in the ability to provide additional excitement and anticipation during play of a poker hand. The player has no control over the draw hand with perhaps the exception of the number of replacement cards that will be provided, which is typically based on the number of cards discarded by the player. With the ongoing need to attract and entertain casino patrons, particularly in today's electronic casino environments, new alluring gaming activities are essential.

An attempt to add excitement over existing gaming activities was made in a poker game described in US Patent Application Publication No. 20120004022 (Inventors: Bradley Berman, et al.) published Jan. 5, 2012. In accordance with one embodiment of this game, a method for facilitating play in a card game is provided. A starting hand of cards is presented, and the player is allowed to select a number (including zero) of cards to hold from the starting hand. Multiple replacement hands (i.e., multiple sets of one or more replacement cards) are presented to the player, where the player is allowed to select a replacement hand(s). A resulting hand(s) is created using the held cards and the replacement hand(s) selected by the player. In more particular embodiments of such a method, conditions may be set such that the player is allowed to select from the multiple replacement hands if the condition has been met. The conditions may include any desired conditions, such as conditions based on the poker rank (i.e. card face values and/or suits) of the held cards. In one embodiment, the player is simply provided with replacement cards if the condition is not met. In another embodiment, the condition may be whether the player needs any replacement cards—e.g., the player may hold all cards and may not need any replacement cards.

There are many other examples of card computer games, including poker. However, for some advanced players the conventional poker games played on computers may not provide enough fun and thrill since they do not possess sufficient complexity and variants of the game rules.

### SUMMARY OF THE INVENTION

In view of the above, it is an object of the present invention to create a new game that combines features of a poker with a computer falling blocks game. Hereinafter this computer poker game will be referred to as a Poker Tetro™.

The goal of the Poker Tetro™ is to score as many points as possible by forming poker hands from square blocks, e.g., playing cards, comprising formations. More specifically, several cards are combined into a card formation. The Card Tetro allows a player to move and/or turn the card formations and to stack the formations to form hands. Cards are used to make hands by stacking card formations on top of each other or next to each other. A card may be displayed by letter designations and images of card suits on top of each block. The formations are dropped from the top of the game container and placed by the player on top of other formations or on the floor of the game container. Formations can be rotated using the navigation keys or the touch screen clockwise or counterclockwise. Cards within the tetramino formation can be moved around in either clockwise or counterclockwise direction. Formations can disintegrate during the fall once the falling formation is partially blocked by the laying cards. The unblocked portion of the formation separates from the rest of the formation and resumes the fall to the lowest point of the container until blocked or stopped by other formations or the floor.

It is understood that the Poker Tetro™ may have a variety of rules resulting from combinations of the Poker and Tetris rules. Therefore some rules given below should be considered only as an example and do not limit the scope of the game application.

Here are some exemplary rules:
1. Formations contain two or more cards.
2. Each formation is placed on top of the other formation or next to each other to create a Card hand.
3. The hand comprises five blocks or cards.
4. The game can be played by one or more people, one on one, or many on many.
5. Formations can be placed intact next to each other, on top of each other, or broken into pieces upon contact with other formations.
6. The falling tetramino card formations can rotate in clockwise and counterclockwise directions.
7. PokerTetro™ can be played on the internet or downloaded and played on a device.
8. The game can be played with one or more decks of cards.
9. Decks may or may not include special cards.
10. The cards that form a winning combination can disappear only within the hand a part of which these cards constitute.

The game contains multiple levels. The player moves up from level to level by accumulating the required number of points at each level. The game accelerates with each level and formations start falling faster. The game ends once the user can no longer navigate a falling tetramino form around existing formations and/or runs of room.

Winning combinations are created by placing the appropriate cards next to each other in a straight line either horizontally or vertically and within the hands of five cards.

The hands which when formed generate points are described below. It is understood that this set of the winning hands consisting of five blocks is given only as an example and that other block/card combinations can be selected for winning the points of the game.

Royal Flush: An Ace, King, Queen, Jack and Ten of the same suit.

Straight Flush Five cards in sequence, of the same suit.

Four of a Kind: Four cards of the same rank, and one side card.

Full House Three cards of the same rank, and two cards of a different, matching rank.

Flush: Five cards of the same suit.

Straight: Five cards in sequence.

Three of a Kind: Three cards of the same rank, and two unrelated side cards.

Two Pair Two cards of a matching rank, another two cards of a different matching rank, and one side card.

One Pair: Two cards of a matching rank, and three unrelated side cards.

Three of the same Suit: Three cards of the same suit and two unrelated side cards.

### BRIEF DESCRIPTION OF THE DRAWINGS

FIGS. 1.0 through 1.2 illustrate a Poker Tetro™ card drop scenario with no “matches” or hands created by the combination of the cards that are dropping and the cards that sit in the foundation on the floor of the game container.

FIGS. 2.0 through 2.3 illustrate a vertical match scenario that corresponds to the Flush with five cards of the same suit.

FIGS. 3.0 through 3.2 illustrate a horizontal row match that corresponds to the Flush.

FIGS. 4.0-4.3 illustrates a Wild Joker Scenario.

FIGS. 5.1 to 5.10 illustrate match scenarios of Table 1.

### DETAILED DESCRIPTION OF THE INVENTION

In view of the above, it is an object of the present invention to create a new game that combines features of a poker with a computer falling blocks game. Hereinafter this computer poker will be referred to as a Poker Tetro™.

The goal of the Poker Tetro™ is to score as many points as possible by forming poker hands from square blocks, e.g., playing cards, comprising formations. More specifically, several cards are combined into a card formation. The Card Tetro allows a player to move and/or turn the card formations and to stack the formations to form hands. Cards are used to make hands by stacking card formations on top of each other or next to each other. A card may be displayed by letter designations and images of card suits on top of each block. The formations are dropped from the top of the game container and placed by the player on top of other formations or on the floor of the game container. Formations can be rotated using the navigation keys or the touch screen clockwise or counterclockwise. Cards within the tetramino formation can be rotated around either clockwise or counterclockwise. Formations can disassemble during the fall once the falling formation is partially blocked by the laying cards. The unblocked portion of the formation separates from the rest of the formation and resumes the fall to the lowest point of the container until blocked or stopped by other formations or the floor.

It is understood that the Poker Tetro™ may have a variety of rules resulting from combinations of the Poker and Tetris rules. Therefore some rules given below should be considered only as an example and do not limit the scope of the game application.

Here are some exemplary rules:
1. Formations contain two or more cards.
2. Each formation is placed on top of the other formation or next to each other to create a Card hand.
3. The hand comprises five blocks or cards.
4. The game can be played by one or more people, one on one, or many on many.
5. Formations can be placed intact next to each other, on top of each other, or broken into pieces upon contact with other formations.
6. Formations can be rotated.
7. PokerTetro™ can be played on the internet or downloaded and played on a device.
8. The game can be played with one or more decks of cards.
9. Decks may or may not include special cards.
10. The cards that form a winning combination can disappear only within the hand a part of which these cards constitute.

The game contains multiple levels. The player moves up from level to level by accumulating the required number of points at each level. The game accelerates with each level and formations start falling faster. The game ends once the user can no longer navigate a falling tetramino card formation falling around existing formations and/or runs of room.

Winning combinations are created by placing the appropriate cards next to each other in a straight line either horizontally or vertically and within the hands of five cards. The hand-forming combination of five cards may be linear or may be L-shaped.

The hands which when formed generate points are shown in Table 1 below. It is understood that this set of the winning hands consisting of five blocks is given only as an example and that other block/card combinations can be selected for winning the points of the game.

TABLE 1

| | |
|---|---|
| Royal Flush | Ace, King, Queen, Jack and Ten of the same suit |
| Straight Flush | Five cards in sequence, of the same suit |
| Four of a Kind | Four cards of the same rank, and one side card |
| Full House | Three cards of the same rank, and two cards of a |
| | different, matching rank |
| Flush | Five cards of the same suit |
| Straight | Five cards in sequence |
| Three of a Kind | Three cards of the same rank, and two unrelated |
| | side cards |
| Two Pair | Two cards of a matching rank, another two cards of a |
| | different matching rank, and one side card |
| One Pair | Two cards of a matching rank, and three unrelated |
| | side cards |
| Three of the | Three cards of the same suit and two unrelated side |
| same Suit | cards |

Thus, during the fall of the falling formation, the player can move the falling formation linearly in the vertical and horizontal direction or can rotate the falling formation within the game frame under control of the navigation keys of the computer in order to stack a falling formation on top of the preceding formation that lays on the frame floor to form a hand. Each hand comprises a predetermined number of cards, five in the examples illustrated below, that can be arranged linearly or in an L-shaped configuration. The specified combinations of cards in a hand provide the player with a winning points and the purpose of the game is to obtain the maximum possible number of winning points.

The invention will be further described in more detail with reference to specific examples that illustrate several possible scenarios. It is understood that the example do not limit the scope of the invention application.

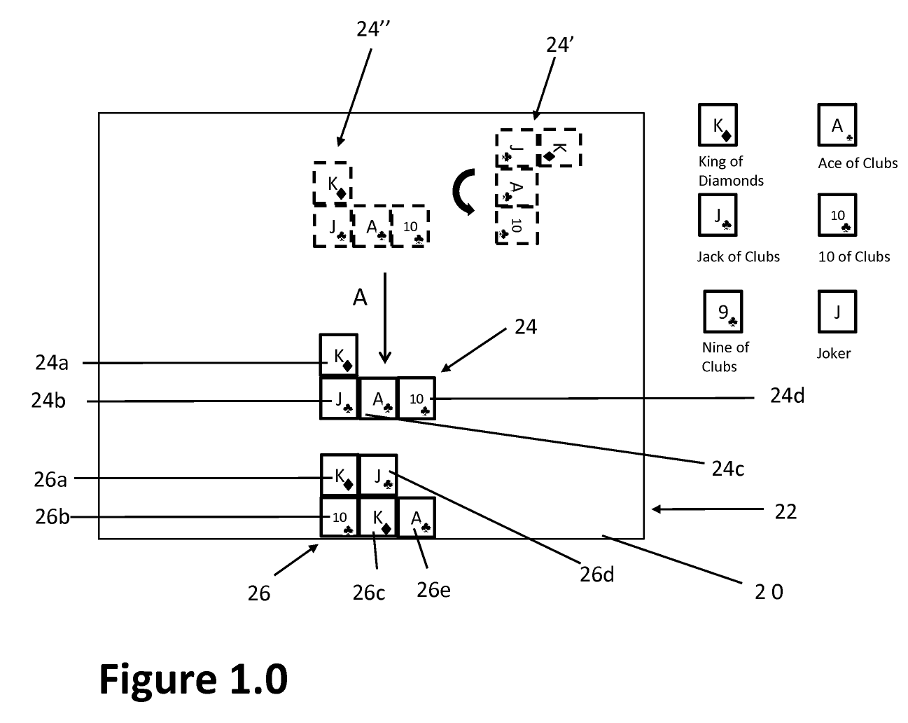

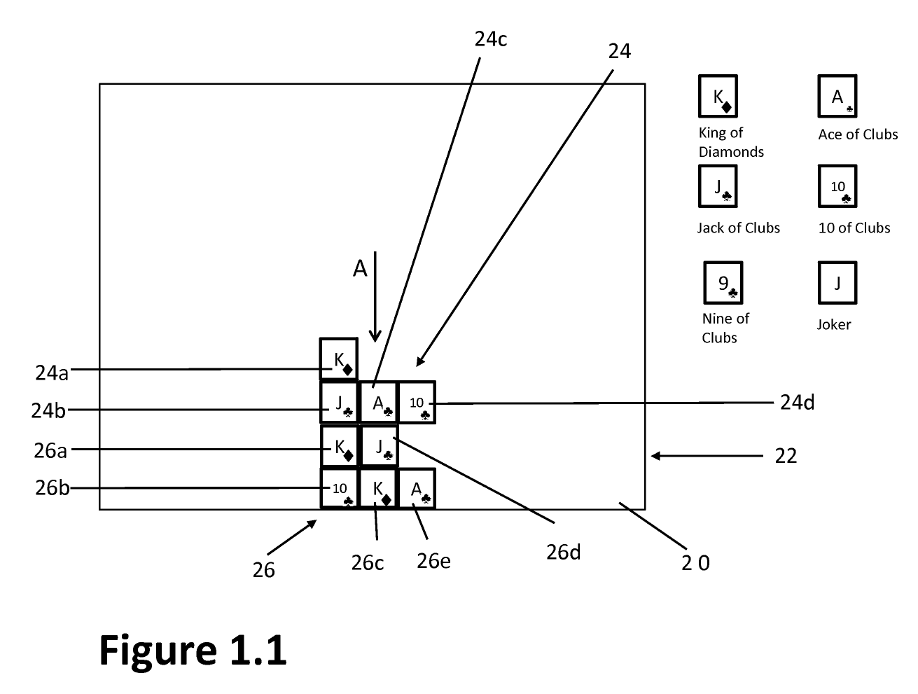

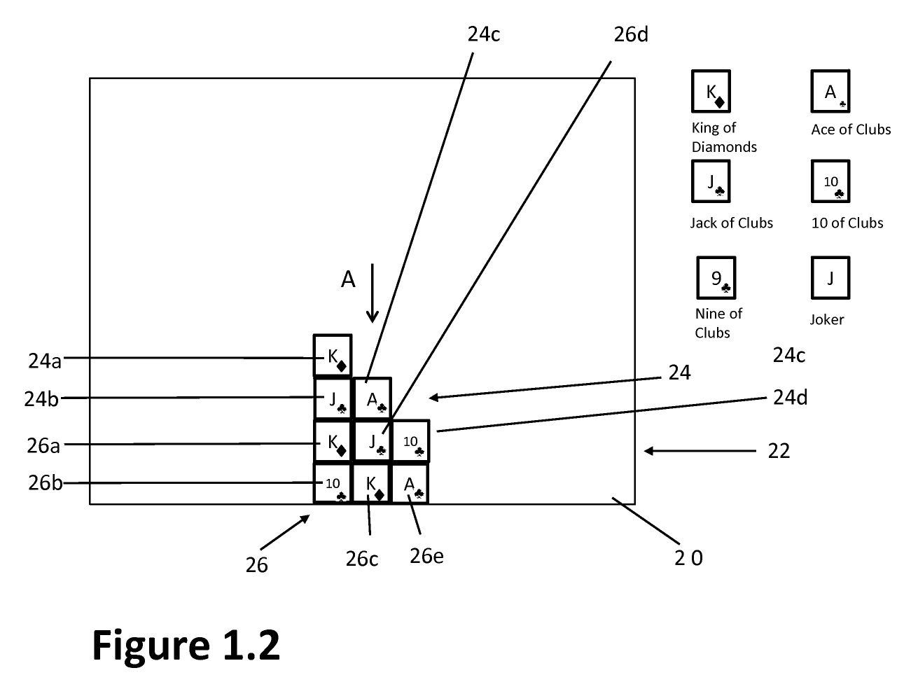

FIGS. 1.0-1.2 No Match Scenario

FIGS. 1.0 through 1.2 illustrate a Poker Tetro™ card drop scenario with no “matches” or hands created by the combination of the cards that are dropping and the cards that sit in the foundation on the floor 20 of the game container 22.

FIG. 1.0 illustrates a scenario where a formation 24 of four blocks, or “cards” 24a, 24b, 24c, and 24d drop over a base 26 of cards 26a, 26b, 26c, 26d, and 26e on the game floor 20. In FIG. 1.0, reference numeral 24′ designate the initial position of the formation 24 when it appears in the game frame 22, and reference numeral 24″ designate an intermediate position of the formation 24 after it was turned by 90° in the counterclockwise direction during falling.

FIG. 1.1 illustrates how the four-card formation 24 will land atop the base formation 26. In these and other drawings, arrow A shows the falling direction. FIG. 1.2 illustrates how the four-card formation 24 will separate and the cards will continue to fall into the open gaps and spaces left in the base. The cards will settle on top of the next lower card. There is no hand, or match, created, given the example in FIG. 1.2, for forming a winning combination. The Ten of Clubs 24d settles on top of the Ace of Club 26e, as well as next to the Jack of Clubs 24d, no hand or match is created to satisfy the hands of Table 1.

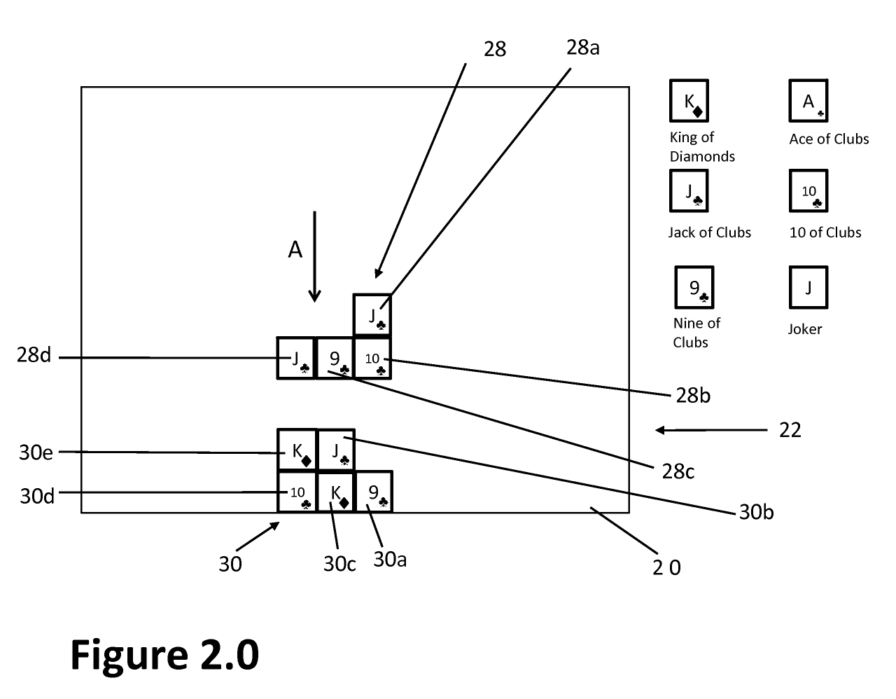

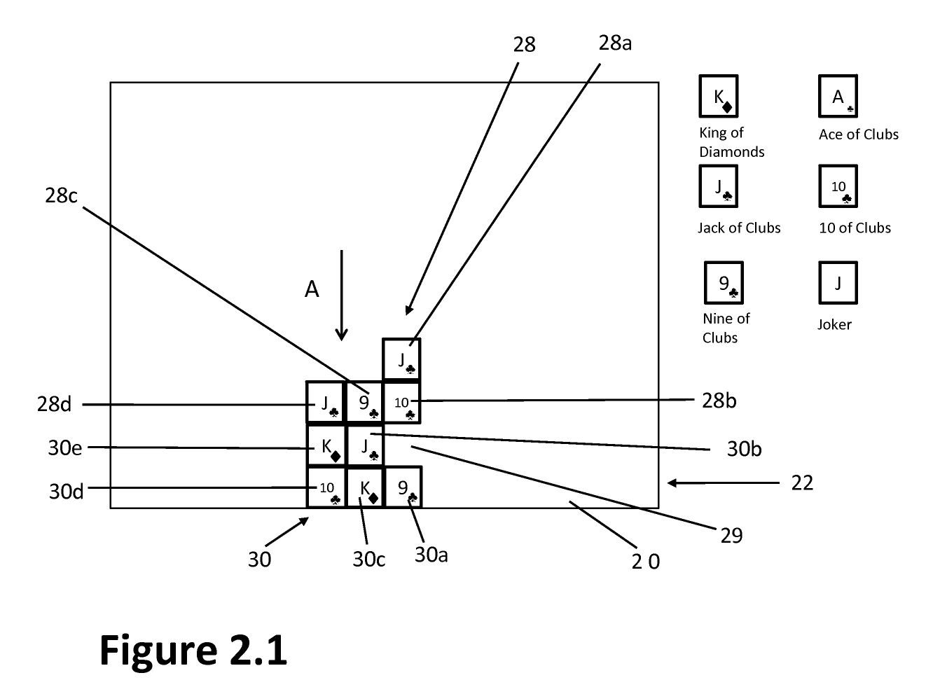

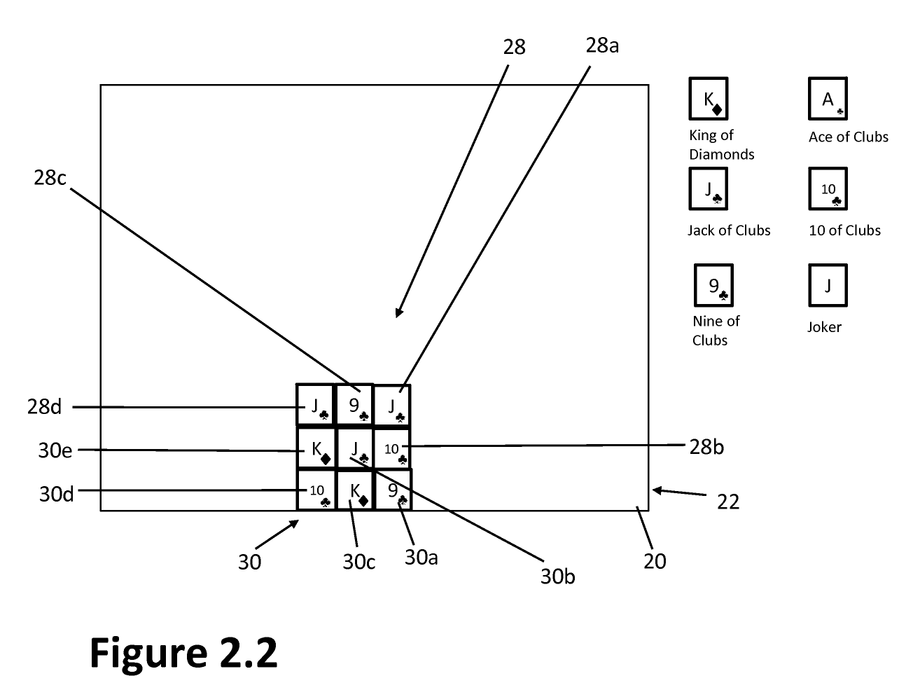

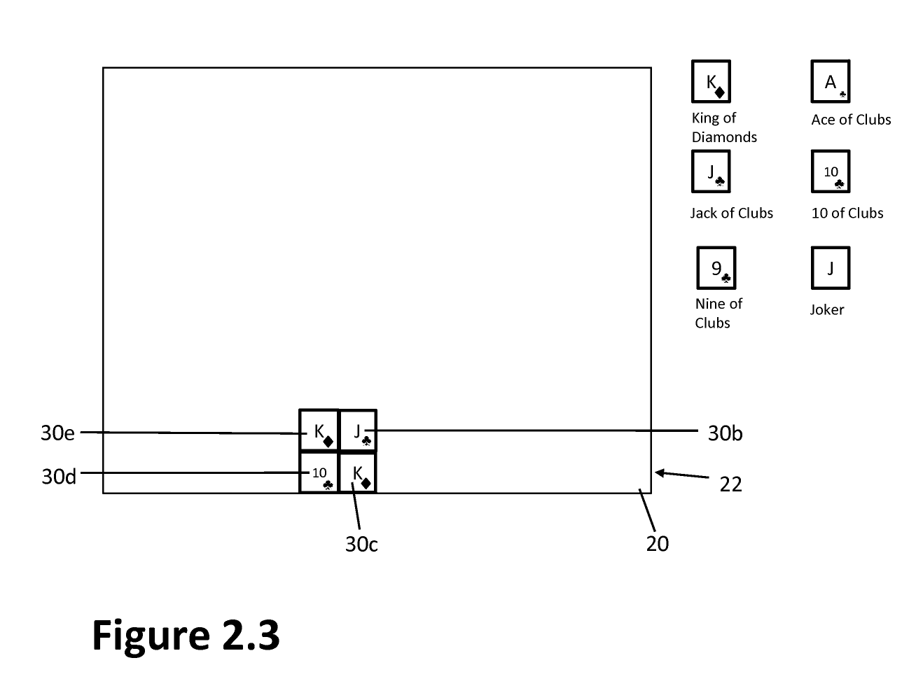

FIG. 2.0-2.3 Vertical Row Match Scenario

FIGS. 2.0 through 2.3 illustrate one of two types of match scenarios. For simplicity of the drawings and explanation, here and hereinafter the intermediate positions of the formations are now shown but it can assumed that prior to the falling position that may lead to a winning situation of FIG. 2.2 that is described below, the falling formation 28 could be rotated and/or moved linearly. The scenario of FIGS. 2.0 to 2.3 illustrate the case of a vertical match where a wining hand is created between the formation 28 of the falling cards 28a, 28b, 28c, and 28d and the card base formation 30 of the cards 30a, 30b, 30c, 30d, and 30e that are settled in the base floor 20 of the game frame 22. FIG. 2.0 presents a scene with a four-card dropping formation 28. The four-card formation 28 will land on top of the base formation 30 (FIG. 2.1) and will separate as the cards 28a and 28b that do not land immediately on the base, will settle into any open gaps or spaces, such as the space 29 (FIG. 2.1) provided in the base of the cards. The cards then settle on top of the base (FIG. 2.2), and in this case, FIG. 2.3 illustrates how a match, or hand, is activated. The settles on top of the Nine of Clubs 30a, with the Jack of Clubs 28a stacked on top of the Ten of Clubs 28b. In the illustrated case the five-card hand has an L-shaped configuration and consists of Jack 28b, Nine 28c, Jack 28a, Ten 28b, and Nine 30a. This corresponds to the Flush with five cards of the same suit. The hand is activated due to the fact that all the cards, i.e., the Nine 30a, Ten 28b, Jack 28a and a pair of horizontally arranged cards Jack 28d and None 28c are Clubs. These cards then disappear leaving an open space or gap, into which nearby cards (not shown) will fall and settle into.

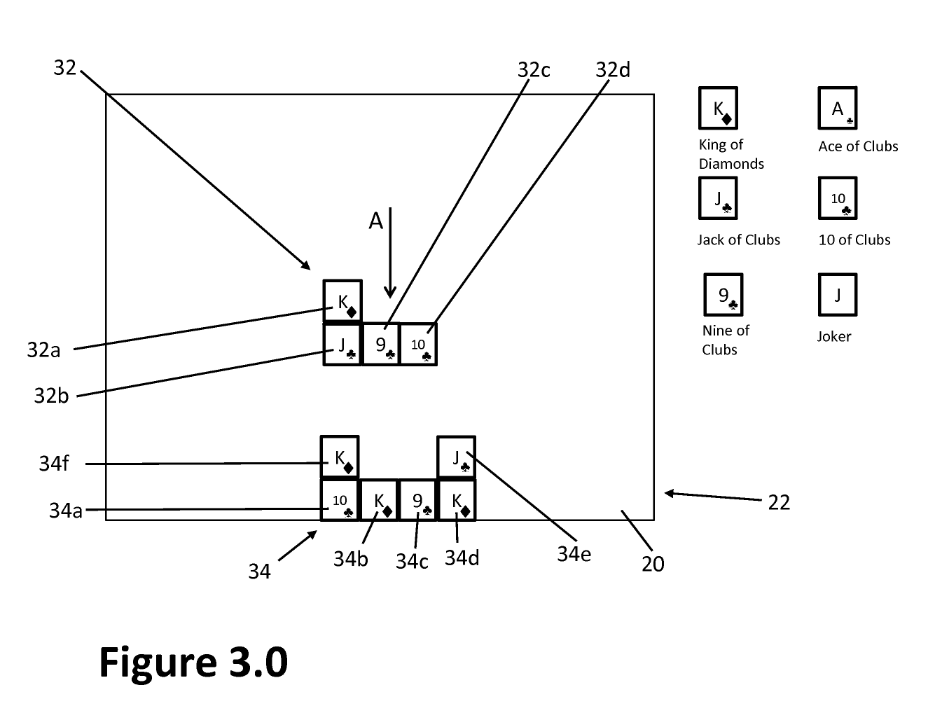

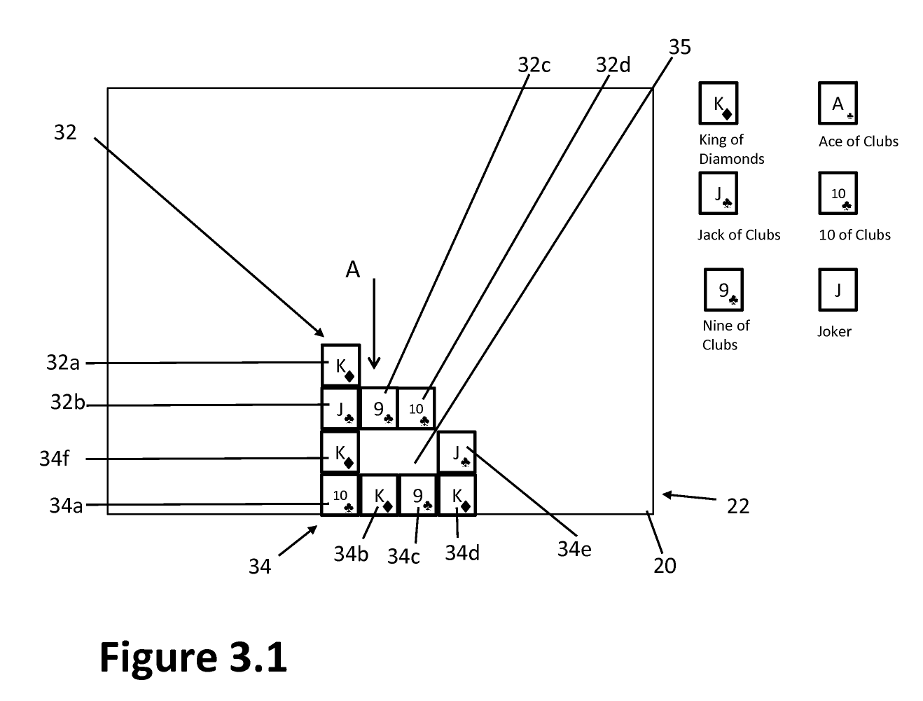

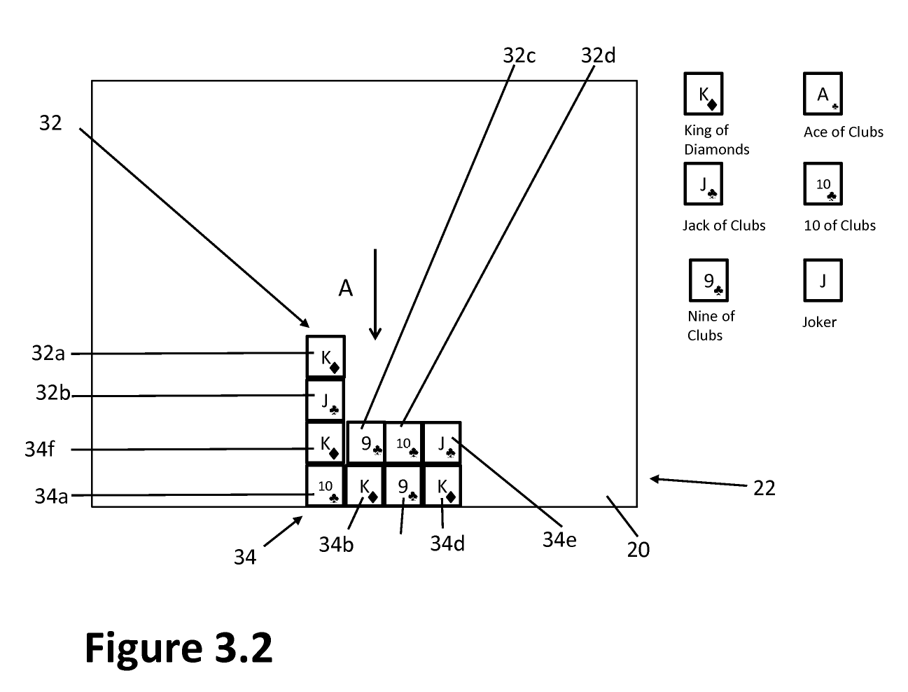

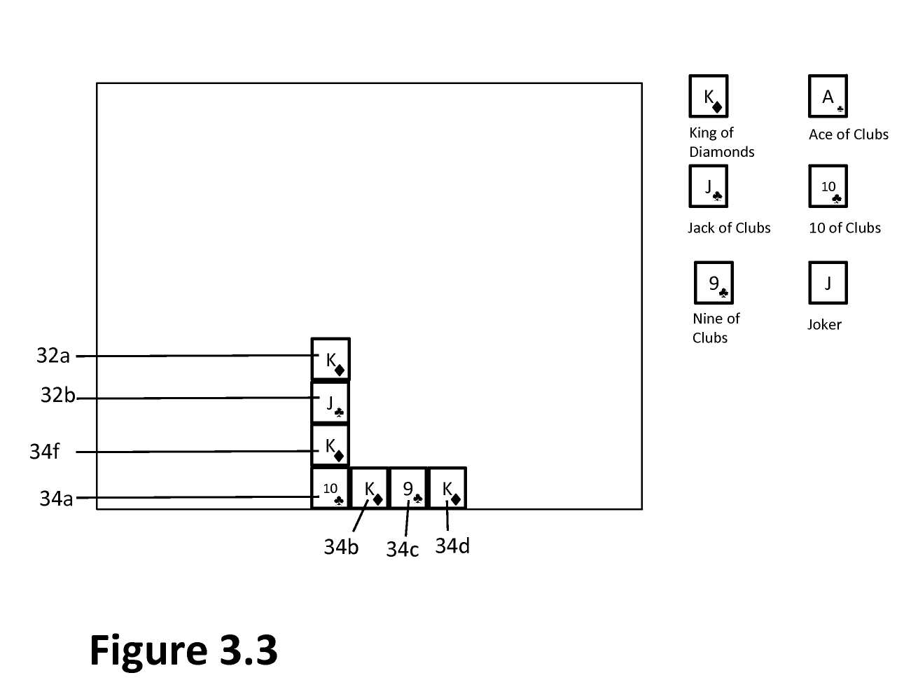

FIGS. 3.0-3.2 Horizontal Row Match Scenario

FIGS. 3.0 through 3.3 illustrate a horizontal row match, or hand created. FIG. 3.0 shows a four-card formation 32 in a drop. The formation 32 that consists of a King of Diamonds 32a, a Jack of Clubs 32b, a Nine of Clubs 32c, and a Ten of Clubs 32d drops and settles on the first formation 34 of cards 34a, 34b, 34c, 34d, 34e, and 34f, on the floor 20 of the game play frame 22. FIG. 3.1 illustrates that the cards 32c and 32d do not initially land on top of the cards 34b and 34c and that an open space 35 is formed between these two sets of the cards. FIG. 3.2 shows the two cards 32c and 32d in the formation 32 settle and then activate a hand. The hand in this example is comprised of a flush of Nine 32c, Ten 32d, and Jack of Clubs 34e. The blocks, or cards 32c, 32d, and 34e are aligned horizontally. FIG. 3.3 illustrates that once a match is created the cards 32c, 32d, and 34e involved in the action disappear. The remaining cards King 34f and Ten 24a of the five-card hand will remain.

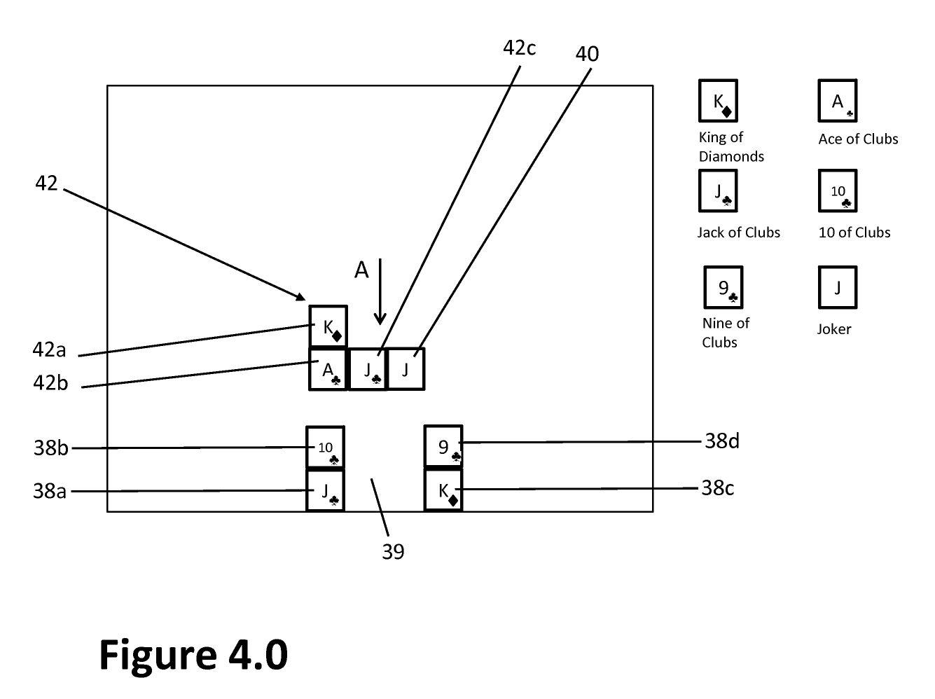

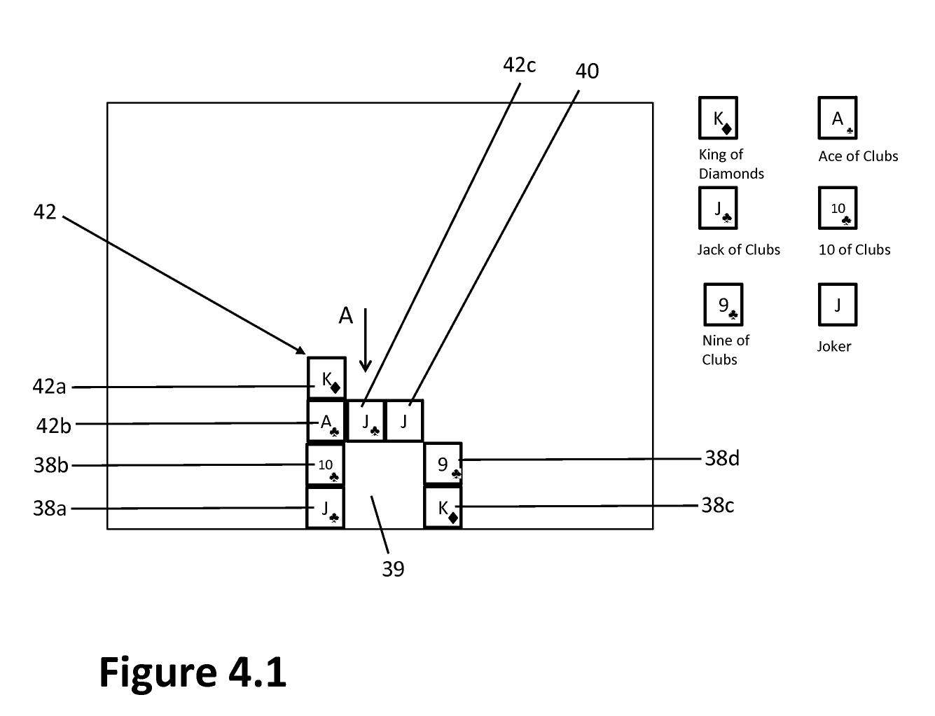

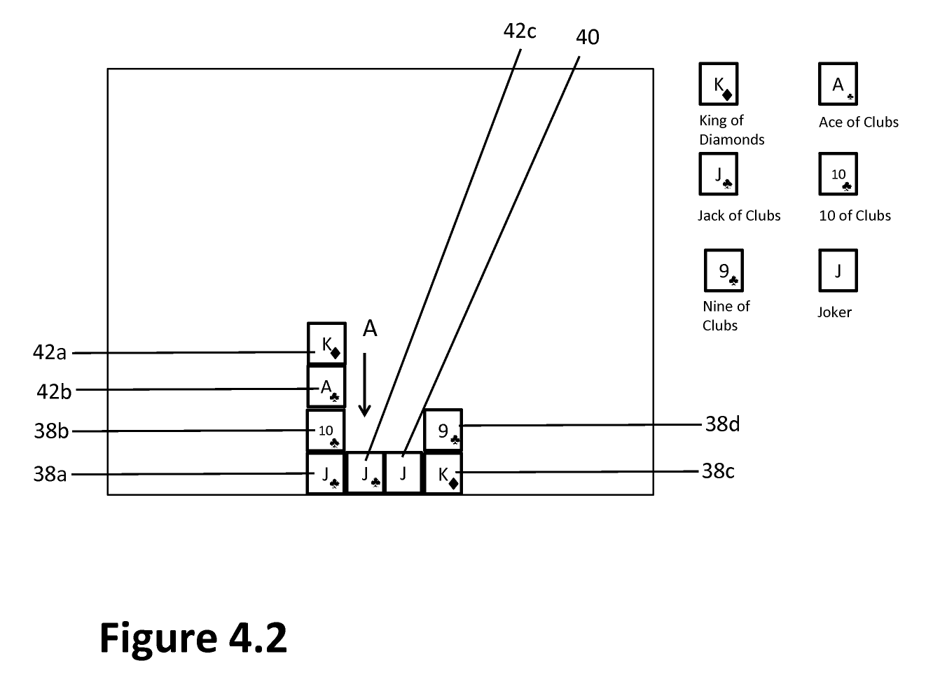

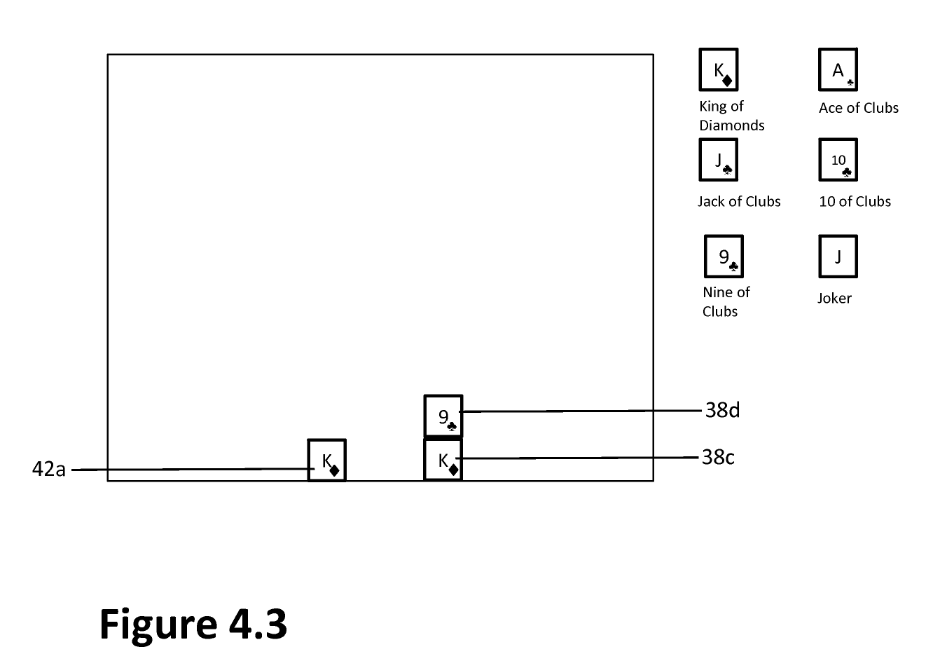

FIGS. 4.0-4.3 Wild Joker Scenario

FIGS. 4.0 through 4.3 illustrate the scenario of a wild joker cube or card 40. The wild joker card 40 will change values according to the hand that the card is played in. In this case the example scenario involves two jacks 38a, 42c, and the joker 40 (FIG. 4.1). The cards 42c and 40 in the formation 42 that settle in the open space 39 fall and land next to a Jack 38a, whereby a five-card hand of the same suite is formed by the cards 42b, 38b, 38a, 42c, and the Joker 40. This is the condition of a strait flush (five cards in sequence, of the same suit). After activation, a picture shown in FIG. 4.3 remains. It can be seen that only the King of Diamonds 24a, the King of Diamonds 38c, and the Nine 38d remain for engagement with the next falling formation (not shown).

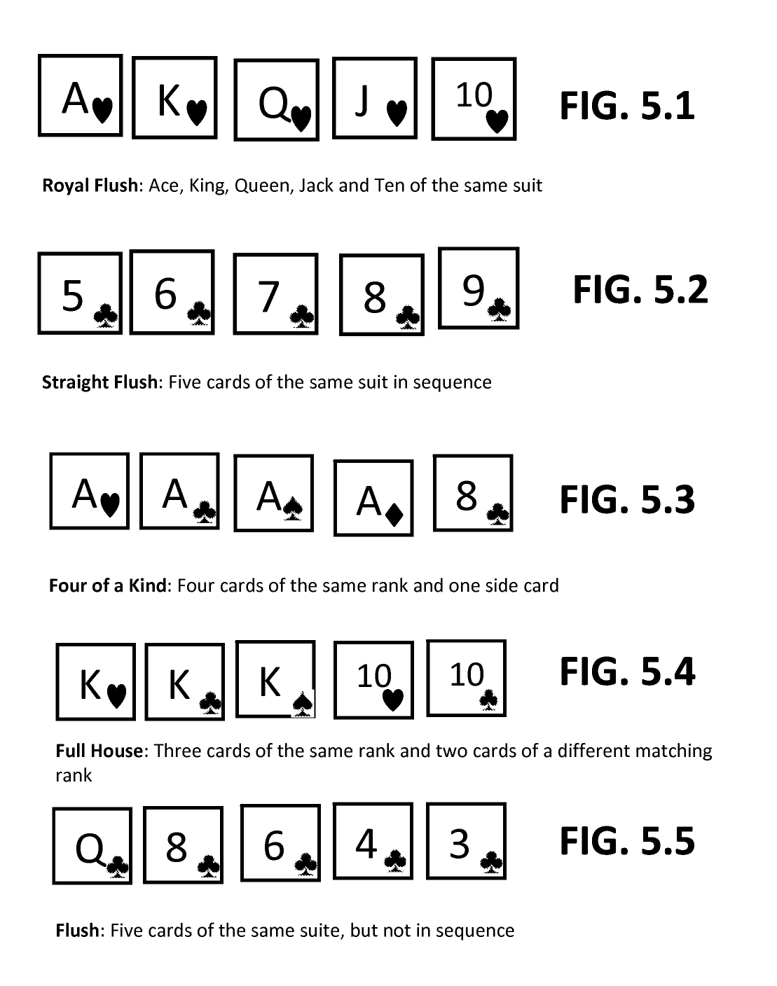

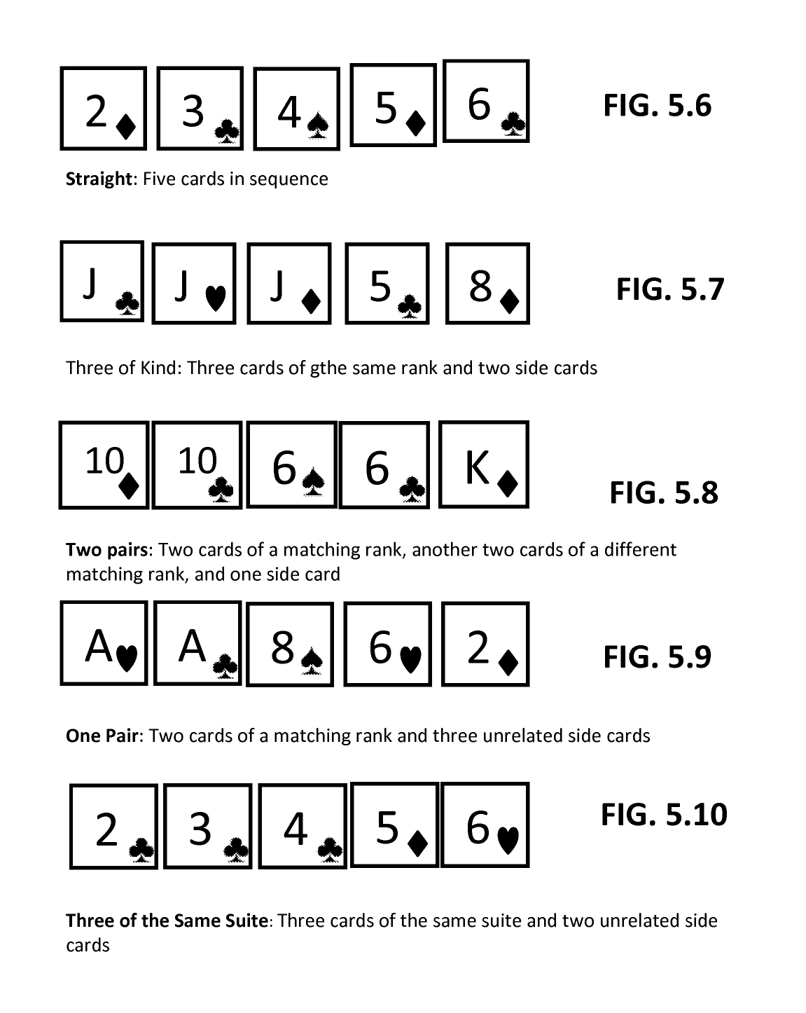

FIGS. 5.1 to 5.10 illustrate match scenarios of Table 1.

Although the invention has been described with reference to specific examples and drawings, it is understood that these examples and drawings should not be construed as limiting the application of the invention and that any changes and modifications are possible without departure from the scope of the attached patent claims. For example, the matching rules that give winning points to a player are shown in Table 1 and in FIGS. 5.1 to 5.6 only as preferable examples and may be different from those in Table 1 and the respective drawings. For example, one of the winning scenarios may comprise four cards in sequence and any Ace, or three Aces and any two cards of the same suit, etc. The cards can be represented by images, numbers, or by combination of images and numbers. Formations may contain as a minimum three cards instead of two. The hand may comprise a number of cards different from five.

What we claim is:

1. A poker tetris computer game to be played on a computer that has navigation keys and a display means, the game comprising:
a game frame having a top and a frame floor displayable on the display means of the computer;
a plurality of game cards of different ranks and different suits that fall in an arbitrary sequence from the top of the game frame to the frame floor;
formations can disintegrate during the fall once the falling formation is partially blocked by the laying cards, the unblocked portion of the falling formation separates from the rest of the formation and resumes the fall until blocked by other formations or by the floor of the game frame;
During the fall of the falling formation, the player can move the falling formation linearly in the vertical and horizontal direction or can rotate the falling formation within the game frame under control of the navigation keys of the computer in order to stack a falling formation on top of the preceding formation that lays on the frame floor to form a hand, each hand comprising a predetermined number of cards that can be arranged linearly or in an L-shaped configuration;
Specified combinations of cards in a hand provide the player with a winning points and the purpose of the game is to obtain the maximum possible number of winning points.

2. The poker tetris computer game according to claim 1, wherein a hand consists of five cards.

3. The poker tetris computer game according to claim 1, wherein winning combinations are created by placing the appropriate cards next to each other in a straight line either horizontally or vertically and within the hands of five cards, the hand-forming combination of five cards may be linear or may be L-shaped.

4. The poker tetris computer game according to claim 2, wherein winning combinations are created by placing the appropriate cards next to each other in a straight line either horizontally or vertically and within the hands of five cards, the hand-forming combination of five cards may be linear or may be L-shaped.

5. The poker tetris computer game according to claim 3, wherein the game contains multiple levels and wherein the player moves up from level to level by accumulating a predetermined number of points at each level.

6. The poker tetris computer game according to claim 4, wherein the game contains multiple levels and wherein the player moves up from level to level by accumulating a predetermined number of points at each level.

7. The poker tetris computer game according to claim 5, wherein the game accelerates with each level and the formations start falling faster.

8. The poker Tetris computer game according to claim 6, wherein the game accelerates with each level and the formations start falling faster.

9. The poker tetris computer game according to claim 5, wherein game ends once the user can no longer navigate a falling around existing formations and/or runs of room.

10. The poker tetris computer game according to claim 6, wherein game ends once the user can no longer navigate a falling tetramino card form around existing formations and/or runs of room.

11. The poker tetris computer game according to claim 1, wherein a winning combination of cards in a hand is one selected from the group consisting of: a) Royal Flush comprising an Ace, King, Queen, Jack and Ten of the same suit; b) Straight Flush comprising five cards in sequence, of the same suit; c) Four of a Kind comprising four cards of the same rank, and one side card; d) Full House comprising three cards of the same rank, and two cards of a different, matching rank; e) Flush comprising five cards of the same suit; f) Straight: Five cards in sequence; g) Three of a Kind: Three cards of the same rank, and two unrelated side cards; and h) Two Pair comprising two cards of a matching rank, another two cards of a different matching rank, and one side card.

12. The poker tetris computer game according to claim 11, wherein a winning combination of cards in a hand comprises three of the same Suit: three cards of the same suit and two unrelated side cards.

13. The poker tetris computer game according to claim 1, wherein a winning combination of cards in a hand is one selected from the group consisting of: a) Royal Flush comprising an Ace, King, Queen, Jack and Ten of the same suit; b) Straight Flush comprising five cards in sequence, of the same suit; c) Four of a Kind comprising four cards of the same rank, and one side card; d) Full House comprising three cards of the same rank, and two cards of a different, matching rank; e) Flush comprising five cards of the same suit; f) Straight: Five cards in sequence; g) Three of a Kind: Three cards of the same rank, and two unrelated side cards; and h) Two Pair comprising two cards of a matching rank, another two cards of a different matching rank, and one side card.

14. The poker tetris computer game according to claim 13, wherein a winning combination of cards in a hand additionally comprises three of the same Suit: three cards of the same suit and two unrelated side cards.

15. The poker tetris computer game according to claim 3, wherein a winning combination of cards in a hand of five cards is one selected from the group consisting of: a) Royal Flush comprising an Ace, King, Queen, Jack and Ten of the same suit; b) Straight Flush comprising five cards in sequence, of the same suit; c) Four of a Kind comprising four cards of the same rank, and one side card; d) Full House comprising three cards of the same rank, and two cards of a different, matching rank; e) Flush comprising five cards of the same suit; f) Straight: Five cards in sequence; g) Three of a Kind: Three cards of the same rank, and two unrelated side cards; and h) Two Pair comprising two cards of a matching rank, another two cards of a different matching rank, and one side card.

16. The poker tetris computer game according to claim 15, wherein a winning combination of cards in a hand of five cards additionally comprises three of the same Suit: three cards of the same suit and two unrelated side cards.

17. The poker tetris computer game according to claim 1, wherein a winning combination of cards in a hand of five cards is one selected from the group consisting of: a) Royal Flush comprising an Ace, King, Queen, Jack and Ten of the same suit; b) Straight Flush comprising five cards in sequence, of the same suit; c) Four of a Kind comprising four cards of the same rank, and one side card; d) Full House comprising three cards of the same rank, and two cards of a different, matching rank; e) Flush comprising five cards of the same suit; f) Straight: Five cards in sequence; g) Three of a Kind: Three cards of the same rank, and two unrelated side cards; and h) Two Pair comprising two cards of a matching rank, another two cards of a different matching rank, and one side card.

18. The poker tetris computer game according to claim 17, wherein a winning combination of cards in a hand of five cards additionally comprises three of the same Suit: three cards of the same suit and two unrelated side cards.
